(19) United States
(12) Patent Application Publication
(10) Pub. No.: US 2016/0332274 A1
(43) Pub. Date: Nov. 17, 2016

(54) Unkown

(71) Applicant: LASERCOMB GMBH, NOTZINGEN (DE)

(72) Inventors: Klaus RENZ, ESSLINGEN (DE); Horst TSCHEULIN, BISSINGEN (DE)

(21) Appl. No.: 15/150,798

(22) Filed: May 10, 2016

(30) Foreign Application Priority Data
May 11, 2015 (DE) 10 2015 107 313.7

(51) Int. Cl. B23Q 17/22; B23P 15/28; B23Q 17/00

(52) U.S. Cl. CPC B23Q 17/2291; B23Q 17/003; B23P 15/28

(57) ABSTRACT

The invention relates to a method for preparing a part-cylindrical rotary cutting die having an outside surface and an inside surface, wherein the outside surface is to be processed at predetermined processing positions for the subsequent realization of a rotary cutting cylinder, said method having the steps:
providing at least two support elements at predetermined support element positions in a processing machine, wherein the support elements are adapted to the inside surface for supporting the rotary cutting die;
providing the rotary cutting die on at least two support elements such that the inside surface is supported on the support elements;
determining the relative position of the rotary cutting die with respect to the support elements;
determining the fastening points between the rotary cutting die and the support elements which are located outside the predetermined processing positions; and
inserting fastening means at the specified fastening points for fastening the rotary cutting die on the support elements.

The invention also relates to a device for preparing a part-cylindrical rotary cutting die having an outside surface and an inside surface, wherein the outside surface is to be processed at predetermined processing positions for the subsequent realization of a rotary cutting cylinder, having a receiving unit for receiving support elements at predetermined positions, a probe for detecting the rotary cutting die, a control unit which is designed to determine the relative position of the rotary cutting die with respect to the support elements and fastening points between the rotary cutting die and the support elements, wherein the fastening points are located outside the predetermined processing positions; and a processing unit for inserting fastening means into the rotary cutting die and into the support elements at the determined fastening points.

### CROSS-REFERENCE TO RELATED APPLICATIONS

The present application claims priority to German national application No. 10 2015 107 313.7, filed May 11, 2015, the contents of which are incorporated herein by reference.

### BACKGROUND OF THE INVENTION

The present invention relates to a method for preparing a part-cylindrical rotary cutting die having an outside surface and an inside surface, wherein the outside surface is to be processed at predetermined processing positions for the subsequent realization of a rotary cutting cylinder. In addition, the invention also relates to a method for preparing a part-cylindrical rotary cutting die.

Rotary cutting dies are used in so-called rotary die-cutters. To form the rotary cutting die, slots are cut into the outside surface of the rotary cutting die, for example by means of a laser or a milling machine, and cutting blades are driven into said slots. Normally, two such semi-cylindrical rotary cutting dies are then clamped on a cutting cylinder such that they complement one another to form a full cylinder. During the cutting operation, the material to be cut, for example cardboard, is guided through a gap between the rotary cutting cylinder and a counter pressure cylinder such that the cutting blades cut into the material whilst the rotary cutting die rolls off along the surface of the material.

To introduce the slots, the, for example, semi-cylindrical rotary cutting die is clamped and positioned in a machine. This normally occurs as a result of manual set up inside or outside the machine in a preparation station. For this purpose, the semi-cylindrical rotary cutting die is mounted on so-called support disks and is fastened in the machine. A varying number of support disks is used in dependence on the length of the rotary cutting die.

The disadvantage of said method is to be found, among other things, in that collisions are always happening between the fastening screws, which are used for fastening the rotary cutting die on the support disks, and the subsequent laser cuts or the milling tracks. In this case, either the screw is destroyed such that it is only able to be removed subsequently with great difficulty, or the milling cutter is affected, which results in increased wear.

### SUMMARY OF THE INVENTION

An object of the present invention, consequently, consists in creating a method and a device which overcome said disadvantages.

The object is achieved by a method with the features of claim 1 and by a device with the features of claim 8.

The method according to the invention includes the steps:

providing at least two support elements at predetermined support element positions in a processing machine, wherein the support elements, for supporting the rotary cutting die, are adapted to the inside surface thereof;

providing the rotary cutting die on at least two support elements such that the inside surface is supported on the support elements;

determining the relative position of the rotary cutting die with respect to the support elements;

determining the fastening points between the rotary cutting die and the support elements which are located outside the predetermined processing positions; and

inserting fastening means at the determined fastening points for fastening the rotary cutting die on the support elements.

This means in other words that when determining and fixing fastening points between the rotary cutting die and the support elements, the processing machine considers where the outside surface is subsequently to be processed, for example to realize the slots. Processing positions which are located in the region of the support elements are recognized by the processing machine and are excluded as possible fastening points.

In other words, no fastening means are mounted at said points such that no collisions can occur subsequently for example between the milling tool and the fastening means.

According to the invention, the position of the rotary cutting die is detected and determined with reference to the support elements for determining such fastening points.

The advantage of said method, on the one hand, is that preparation of the rotary cutting die is able to be automated and, on the other hand, the fastening to the support elements is effected such that subsequent impairment of the processing, for example as a result of a laser or a milling cutter, is able to be avoided.

In the case of a preferred further development, the determination of the relative position of the rotary cutting die with respect to the support elements is effected using a probe which is moved from one support element position to the next until the rotary cutting die is detected. In a preferred manner, once the rotary cutting die has been detected at one support element position, the probe continues to be moved in order to detect the end of the rotary cutting die.

This means in other words that the probe is moved to the positions of the support elements filed in the system of the processing machine in order to check in each case whether the rotary cutting die rests on the support element approached. If this is the case, the probe continues to be moved along the rotary cutting die in order to detect the end (i.e. the longitudinal end) of the cutting die. If the longitudinal end of the cutting die is detected, the system of the processing machine, with the aid of the filed overall length of the rotary cutting die, is able to determine, on the one hand, the position inside the processing machine and, on the other hand, the relative position with respect to the support elements.

In the case of a preferred further development, the rotary cutting die with the processing positions and the positions of the support elements are shown on a display device, and fastening points predetermined first of all by the processing machine are also displayed.

This means in other words that the operator is able to recognize on the display device where the system has located the fastening points at which the fastening means are inserted to connect the rotary cutting die and the support element. As the processing positions at which, for example, slots are added, are also displayed to the operator, the operator is able to ascertain whether the fastening points are located in the region of the processing positions.

If this is the case, the operator is able to move the located fastening points such that they are not located in the region of the processing positions.

In the case of a preferred further development, the fastening points which are located at processing positions are marked by the processing machine.

The automatic marking of such fastening points which are not to be utilized simplifies the operation.

In the case of a preferred further development, the processing machine modifies at least the marked fastening points, i.e. the fastening points not to be used, in such a manner that the fastening points are located outside the processing positions.

The advantage is that the operator no longer has to intervene as the system of the processing machine detects the fastening points not to be used and is automatically able to modify them.

The object underlying the invention is also achieved by a device which comprises a receiving unit for receiving support elements at predetermined positions, a probe for detecting the rotary cutting die, a control unit which is designed to determine the relative position of the rotary cutting die with respect to the support elements and fastening points between the rotary cutting die and the support elements, wherein the fastening points are located outside the predetermined processing positions, and a processing unit for inserting fastening means into the rotary cutting die and into the support elements at the determined fastening points.

Said device, which serves for carrying out the aforementioned method, has the same advantages such that it is possible to dispense with a further statement thereof.

In the case of a preferred further development, the probe and the processing unit are realized so as to be movable and adjustable. In a further preferred manner, the receiving unit is rotatable at least over a predetermined angular range, preferably between −90° and +90°.

It is obvious that the features named above and those yet to be explained below are usable not only in the combination provided in each case, but also in other combinations or standing alone without departing from the scope of the present invention.

### BRIEF DESCRIPTION OF THE DRAWINGS

Further advantages and embodiments of the invention are produced from the description and the accompanying drawing, in which:

FIG. 1 shows a front view of a schematic representation of a processing machine;

FIG. 2 shows a schematic representation of an outside surface of a rotary cutting die;

FIG. 3 shows a perspective view of a rotary cutting die; and

FIG. 4 shows a flow diagram to explain the method according to the invention.

### DETAILED DESCRIPTION OF THE PREFERRED EMBODIMENTS

FIG. 1 shows a highly simplified representation of a processing machine which is characterized by the reference 10. The processing machine 10 serves for the purpose of preparing a rotary cutting die for the processing thereof. The processing is, in particular, the addition of slots into the outer surface of the rotary cutting die and the insertion of cutting blades into the slots. The addition of slots is normally effected by means of laser or milling processes.

It is necessary to said process for the preferably semi-cylindrical rotary cutting die (with a diameter within the range of, for example, between 174 mm and 808 mm) to be reinforced on the inside surface by preferably plate-shaped support elements. Said support elements are connected to the rotary cutting die by means of detachable fastening means and after the processing of the outside surface of the rotary cutting die are removed again. The rotary cutting die with the inserted cutting blades can then be clamped onto a cutting cylinder.

The processing machine 10 comprises a processing table 12 which is realized to receive support elements 14 at predefined positions, so-called support element positions. The distances between the support element positions are preferably chosen so as to be irregular, in particular increasing, i.e. becoming greater, from left to right (with reference to FIG. 1) in the x direction.

The processing machine 10 additionally includes a sensor unit 16 which is movable along a rail 18 in the x direction. The sensor unit 16 includes a probe 20 which is movable, i.e. adjustable, in the z direction. The sensor unit 16 with the probe 20 is designed to detect the top surface of a rotary cutting die inserted into the processing machine 10. Over and above this, the probe 20 is realized such that it is able to slide over the top surface of the rotary cutting die as a result of moving the sensor unit 16 in the x direction and is thus able to detect the longitudinal extension of the rotary cutting die in the x direction.

The processing machine 10 additionally comprises a processing unit 22 which is preferably also mounted on the rail 18 so as to be displaceable in the x direction. At least one processing tool 24, which comprises, for example, a screwdriver element with a screw hopper, is mounted on the processing unit 22. By means of the processing tool 24, fastening means, for example screws, are to be screwed in from above through the rotary cutting die into the support elements 14 which are located below in order to fasten the rotary cutting die to the support elements 14.

To carry out the preparation or processing steps in an automated manner, the processing machine 10 comprises a control unit 30 which normally includes a display 32 and an input keyboard 34.

A semi-cylindrical rotary cutting die, which is characterized by the reference 40 and is shown as a longitudinal section, can also be seen in FIG. 1. In FIG. 1, the semi-cylindrical rotary cutting die 40 is placed onto the support elements 14 shown such that in a next step it could be fastened to the support elements.

The rotary cutting die 40 is shown again in FIG. 3 in a perspective representation. The rotary cutting die 40 is a part-cylindrical, preferably semi-cylindrical shell with an inside surface 42 and an outside surface 44. The rotary cutting die 40 is clamped with one or several further rotary cutting dies onto a cylinder such that the individual outside surfaces of the rotary cutting dies complement one another to form a complete cylindrical surface.

The outside surface 44 of the rotary cutting die 40, as already mentioned, is processed with the aid of a laser process or a milling process, in particular is provided with slots in order to be able to insert cutting blades.

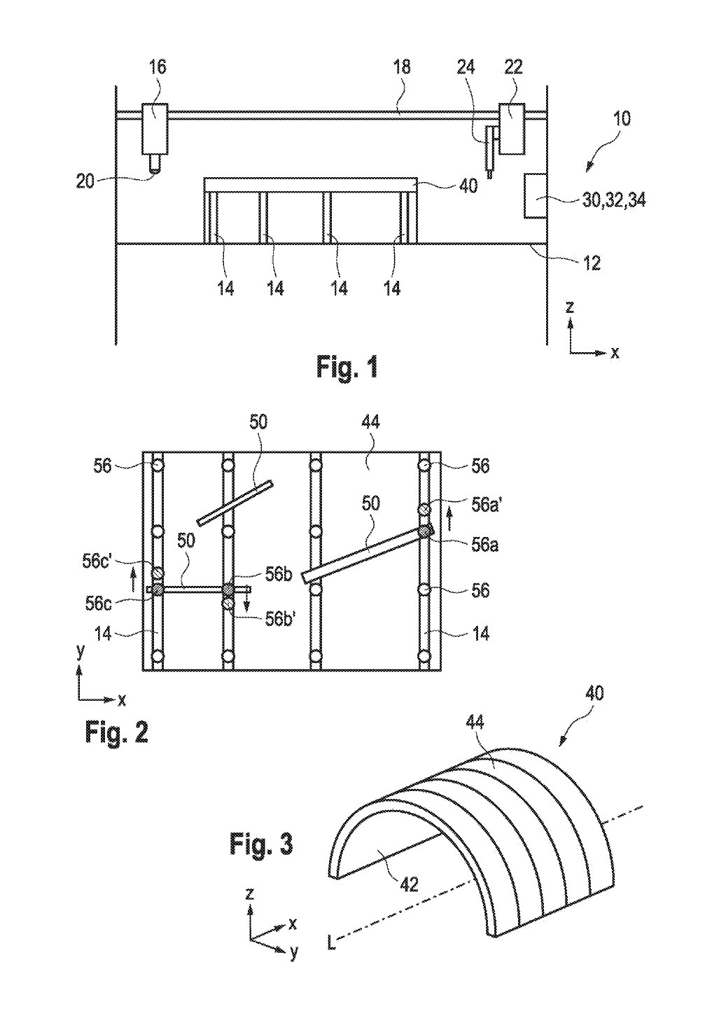

FIG. 2 shows the outside surface 44 of the rotary cutting die 40 in the unbent shape as a planar surface. In addition, said representation shows the support elements 14 which abut against the inside surface 42 and to which the rotary cutting die is to be screw-connected. Elongated rectangles 50, which identify the processing positions at which slots are subsequently to be added, are additionally shown.

Finally, circular elements 56, which identify each position at which screws are to be mounted to fasten support elements to the rotary cutting die, are also shown in the region of the support elements 14. The image shown in FIG. 2 produced from several elements located one on top of another can be shown on the display 32 of the processing machine 10.

It can be seen in FIG. 2 that some circular elements 56 are located in the region of the rectangles 50. Said circular elements 56 are characterized by the references 56a, b and c.

If a screw connection were to be effected at said points, the milling head, for example, would come into contact with a screw during the subsequent processing, which would result in damage to the milling head and the screw.

In order to avoid this, the circular elements 56a, b, c are either to be deleted or to be moved. Deleting means that a screw connection at said point is abandoned. Moving means that the screw connected is effected at another point.

In FIG. 2, the circular elements 56a, b, c are moved up or down and are characterized by the references 56a′, b′ and c′. This means that the screw connection is effected at a changed point, namely at the points 56a′, b′ and c′.

The locating of the critical circular elements, i.e. those that have to be deleted or modified, can be provided by the control unit or, as an alternative to this, by a user.

If the control unit takes over the locating of said critical circular elements, it can mark the located elements 56 on the display, for example in a colored manner, such that the user is able to move the marked elements in the y direction by means of the input keyboard 34 or, alternatively, is able to delete them.

It is obviously also conceivable for the control unit 30 to displace the located critical elements 56 independently in the y direction in such a manner that they are no longer located in the region of the rectangles 50 which characterize the processing positions.

As soon as all the critical elements 56 have been moved or deleted, the screw connection can be performed with the aid of the processing tool 24 at the points marked by the circular elements 56.

Once all the screws for fastening are inserted, the further processing of the rotary cutting die 40 can be performed, in particular the adding of the slots at the processing positions. In a preferred manner, said processing step can also be performed in the processing machine 10 such that the transferring of the rotary cutting die with the screw-connected support elements 14 to a further processing machine can be omitted.

The method for preparing the rotary cutting die 40 now comprises the follow steps:

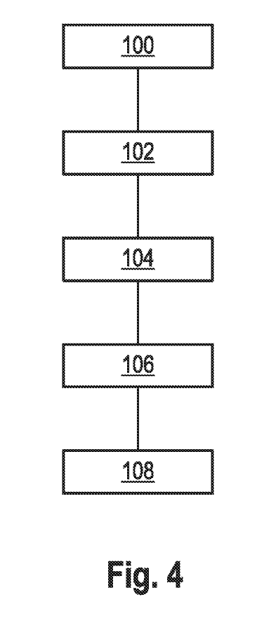

First of all, the rotary cutting die 40 is placed into the processing machine 10 such that it rests on at least some of the support elements 14 which are arranged at the pre-defined positions, step 100 in FIG. 4.

In the next step, the probe 20 is moved into the first (for example proceeding from the left; FIG. 1) pre-defined position of a support element. At said position, the probe 20 checks whether the rotary cutting die 40 is at said position. If this is not the case, the sensor unit 16 moves with the probe 20 into the next pre-defined position in order to scan there once again.

If the probe 20 detects a rotary cutting die 40, the sensor unit 16 moves with the probe 20, which rests on the outside surface 44 of the rotary cutting die 40, further to the right up until the probe detects the end of the rotary cutting die 40 (step 102).

As a result of said operation, the control device 30 now knows the covered support elements 14, the position of the one end of the rotary cutting die (the right-hand end in FIG. 1) and, as a result of calculation, also the position of the other end of the rotary cutting die as the overall length of the rotary cutting die 40 is known as a result of, for example, a prior input.

Consequently, the control unit 30 also knows the relative position of the support elements 14 with respect to the rotary cutting die 40 such that, for example, a first part of the image shown in FIG. 2 can be shown on the display.

In the next step, the processing positions, which have also been input beforehand and are known to the control unit, are superimposed into the image in the form of the rectangles 50 and in addition also the circular elements, which are set by the processing unit 30 according to a predetermined pattern, are preferably distributed regularly along a support element and show the fastening points. The number of fastening points can be chosen in a preferred manner in dependence on the diameter of the rotary cutting die 40, for example four fastening points per support element in the case of smaller diameters and correspondingly more in the case of larger diameters.

Whether fastening points are located inside processing positions is checked in the next step. If this is the case, the fastening point is deleted or moved in the y direction.

As soon as all the fastening points are located outside the processing positions, i.e. the rectangles 50, the control unit 30 causes the processing unit 22 with the processing tool 24 to insert fastening means, for example screws, at the specified fastening points; step 106. In order to make each point along the circumference of the rotary cutting die 40 reachable by the processing tool 24, the processing table 12 is rotatable about the x axis such that the processing tool 24 only has to be movable in the x and the z direction.

The preparation is completed as soon as all the fastening means are inserted, in the present exemplary embodiment four screws per support element and consequently 16 screws in total. The rotary cutting die 40, which is reinforced by way of the support elements 14, can then be provided with slots at the processing positions in a following step either in the processing machine 10 or in another processing machine.

1. A method for preparing a part-cylindrical rotary cutting die having an outside surface and an inside surface, wherein the outside surface is to be processed at predetermined processing positions for the subsequent realization of a rotary cutting cylinder, said method comprising:
providing at least two support elements at predetermined support element positions in a processing machine, wherein the support elements, for supporting the rotary cutting die, are adapted to the inside surface;
providing the rotary cutting die on at least two support elements such that the inside surface is supported on the support elements;
determining the relative position of the rotary cutting die with respect to the support elements;
determining the fastening points between the rotary cutting die and the support elements which are located outside the predetermined processing positions; and
inserting fastening means at the specified fastening points for fastening the rotary cutting die on the support elements.

2. The method as claimed in claim 1, wherein the determination of the relative position of the rotary cutting die with respect to the support elements is effected using a probe which is moved from one support element position to the next until the rotary cutting die is detected.

3. The method as claimed in claim 2, wherein once the rotary cutting die has been detected at one support element position, the probe continues to be moved in order to detect the end of the rotary cutting die.

4. The method as claimed in claim 3, wherein the rotary cutting die with the processing positions and the positions of the support elements are shown on a display device, and wherein fastening points determined by the processing machine are displayed.

5. The method as claimed in claim 4, wherein the fastening points which are located at processing positions are marked.

6. The method as claimed in claim 5, wherein a user can modify at least the marked fastening points in order to prevent fastening points from being located in processing positions.

7. The method as claimed in claim 5, wherein the processing machine modifies at least the marked fastening points in such a manner that the fastening points are located outside the processing positions.

8. A device for preparing a part-cylindrical rotary cutting die having an outside surface and an inside surface, wherein the outside surface is to be processed at predetermined processing positions for the subsequent realization of a rotary cutting cylinder, comprising:
a receiving unit for receiving support elements at predetermined positions;
a probe for detecting the rotary cutting die;
a control unit which is designed to determine the relative position of the rotary cutting die with respect to the support elements and fastening points between the rotary cutting die and the support elements, wherein the fastening points are located outside the predetermined processing positions; and
a processing unit for inserting fastening means into the rotary cutting die and into the support elements at the determined fastening points.

9. The device as claimed in claim 8, wherein the probe and the processing unit are movable and adjustable.

10. The device as claimed in claim 8, wherein the receiving unit is rotatable at least over a predetermined angular range, between −90° and +90°.

11. The device as claimed in claim 9, wherein the receiving unit is rotatable at least over a predetermined angular range, between −90° and +90°.
